(19) United States
(12) Patent Application Publication
(10) Pub. No.: US 2025/0093502 A1
(43) Pub. Date: Mar. 20, 2025

(54) ULTRASONIC MAPPING SYSTEM

(71) Applicant: GOOGLE LLC, Mountain View, CA (US)

(72) Inventor: Dongeek Shin, Mountain View, CA (US)

(21) Appl. No.: 18/289,927

(22) PCT Filed: Dec. 14, 2022
(86) PCT No.: PCT/US2022/052806

§ 371 Date: Nov. 8, 2023

(51) Int. Cl. G01S 15/89; G01C 21/16; G01S 7/54; G01S 15/10; G01S 15/42; G01S 15/58; G01S 15/86

(52) U.S. Cl. CPC G01S 15/89; G01C 21/1652; G01S 7/54; G01S 15/102; G01S 15/42; G01S 15/588; G01S 15/86

(57) ABSTRACT

To determine a location of a user, a computing device transmits an audio signal via a speaker and receives a reflected audio signal via a microphone. The computing device obtains sensor data from at least one of: one or more positioning sensors, one or more accelerometers, one or more gyroscopes, or one or more inertial measurement units, and determines a location of a user based on (i) a round trip time of the audio signal and the reflected audio signal, and (ii) the sensor data.

### FIELD OF THE DISCLOSURE

This disclosure relates to an ultrasonic mapping system, and more particularly to fusing location estimates based on reflected audio signals with location estimates from GPS sensors and IMUs to accurately determine a user's location.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Today, computing devices typically use global positioning system (GPS) sensors to determine their respective locations. However, GPS sensors cannot locate a device with pinpoint accuracy.

To increase location accuracy some computing devices using a Visual Positioning System (VPS) which require the user to perform certain steps to scan their environment, such as pointing their computing device at neighboring buildings or geographic features. However, the user may have difficulty performing these steps and they can be time consuming. Additionally, each time the user moves to a different location, the user may have to scan their environment once again to determine their precise location.

### SUMMARY

To precisely locate a user, an ultrasonic mapping system including the user's computing device continuously or periodically transmits an audio signal via a speaker, which may be a coded impulse signal, and receives a reflected audio signal via a microphone when the audio signal bounces off a wall or other object, which may be a response impulse signal corresponding to the coded impulse signal. The user's computing device then determines the distance from the wall or other object based on a round trip time of the audio signal and the reflected audio signal. Additionally, the user's computing device determines its location and/or orientation using sensor data from a GPS, accelerometer, gyroscope, inertial measurement unit (IMU), etc. Then the user's computing device combines the distance measurement from the round trip time of the audio signal and the reflected audio signal with the location/orientation information from the sensor data to determine a precise location of the user.

For example, the user's computing device may determine a change in position of the user based on a change in a first round trip time of a first audio signal/first reflected audio signal during a first time period and a second round trip time of a second audio signal/second reflected audio signal during a second time period. The user's computing device may also determine its orientation using sensor data from the accelerometer, gyroscope, IMU, etc. Then the user's computing device may determine its location based on the change in position and the direction of movement.

In another example, the user's computing device may include multiple microphones at multiple positions within the computing device. The computing device may then receive a reflected audio signal at each of the microphones. The computing device may determine a direction of arrival of the reflected audio signal based on a time difference at which each of the microphones received the reflected audio signal. Then the computing device may determine its location based on the change in position of the user and the direction of arrival.

In yet other examples, the user's computing device may determine a first location estimate with a first confidence interval based on the round trip time of the audio signal and the reflected audio signal. The user's computing device may also determine a second location estimate with a second confidence interval based on sensor data from the GPS, accelerometer, gyroscope, inertial measurement unit (IMU), etc. Then the user's computing device may determine its location by applying the location estimates to a particle filter. The particle filter may combine the locations and confidence levels to determine a location with a lower margin of error than the confidence levels for the individual location estimates. The particle filter may combine the locations and confidence levels in any suitable manner, such as assigning weights to each of the locations. The particle filter may also generate probability distributions for the locations in accordance with their respective confidence levels (e.g., using a Gaussian distribution where the confidence level corresponds to two standard deviations). The particle filter may then combine the probability distributions for the locations using Bayesian estimation to calculate a minimum mean square (MMS) estimate.

More specifically, the particle filter may obtain N random samples of the probability distributions called particles to represent the probability distributions and assigns a weight to each of the N random samples. The particle filter then combines weighted particles to determine the location having a confidence level with a lower margin of error than the confidence levels for the individual location estimates.

In another example, the user's computing device may determine its location by obtaining a machine learning model trained using (i) several round trip times of audio signals and reflected audio signals, (ii) several sets of sensor data from positioning sensors, accelerometers, gyroscopes, IMUs, etc., and (iii) known locations each corresponding to one of the round trip times and one of the sets of sensor data. For example, the machine learning model may be trained at a server device which receives known locations of users and round trip times and sets of sensor data corresponding to each known location.

The user's computing device applies the round trip time, sensor data, changes in round trip times over time, changes in the sensor data over time, other characteristics of the reflected audio signal, and/or any other suitable information to the machine learning model to determine the location of the user.

In some implementations, the ultrasonic mapping system determines indoor locations for the user. In other implementations, the ultrasonic mapping system determines both indoor and outdoor locations for the user.

Also in some implementations, the sensor data and/or the reflected audio signals may be received at multiple computing devices communicatively coupled to each other. For example, the user may have a smartphone, a smart watch, and smart earbuds. Any or all of the smartphone, smart watch, and smart earbuds may transmit audio signals and receive reflected audio signals. Additionally, any or all of the smartphone, smart watch, and smart earbuds may obtain sensor data from sensors within the respective computing devices. The smartphone, smart watch, and smart earbuds may communicate with each other via a short-range communication link, such as Bluetooth™, Wi-Fi, etc. One of the computing devices may receive the sensor data and round trip times obtained at each of the computing devices and may analyze the sensor data and round trip times to determine the location of the user.

In any event, by using both round trip times from transmitted and reflected audio signals and sensor data from sensors within the user's computing device(s), the ultrasonic mapping system can determine the location of the user with pinpoint accuracy (e.g., about one meter accuracy), which is significantly higher than with GPS sensors, without requiring the user to scan their environment. Additionally, the user's location can be updated as the user moves throughout a geographic area without the user needing to repeatedly scan their environment.

An example embodiment of these techniques is a method in a computing device for determining a location of a user. The method includes transmitting, via a speaker, an audio signal, and receiving, via a microphone, a reflected audio signal. The method also includes obtaining sensor data from at least one of: a positioning sensor, an accelerometers, a gyroscope, or an inertial measurement unit (IMU), and determining a location of a user based on (i) a round trip time of the audio signal and the reflected audio signal, and (ii) the sensor data.

Another example embodiment of these techniques is a computing device for determining a location of a user. The computing device includes a speaker, a microphone, at least one of: (i) a positioning sensor, (ii) an accelerometer, (iii) a gyroscope, or (iv) an inertial measurement unit (IMU), one or more processors, and computer-readable memory storing instructions thereon. When executed by the one or more processors, the instructions cause the computing device to transmit, via the speaker, an audio signal, receive, via the microphone, a reflected audio signal, obtain sensor data from the at least one of: the positioning sensor, the accelerometer, the gyroscope, or the IMU, and determine a location of a user based on the sensor data and a round trip time of the audio signal and the reflected audio signal.

Yet another example embodiment of these techniques is a computer-readable memory, which may be non-transitory, coupled to one or more processors and storing instructions thereon. The instructions cause the one or more processors to transmit, via a speaker, an audio signal, receive, via a microphone, a reflected audio signal, obtain sensor data from the at least one of: a positioning sensor, an accelerometer, a gyroscope, or an inertial measurement unit (IMU), and determine a location of a user based on the sensor data and a round trip time of the audio signal and the reflected audio signal.

### BRIEF DESCRIPTION OF THE DRAWINGS

FIG. 1 is an example coded impulse signal which is transmitted as an audio signal via a speaker and received as a reflected audio signal at a microphone to determine the distance between a user's computing device and an object, such as a wall;

FIG. 2 is an example schematic diagram of a user's computing device transmitting an audio signal and receiving the audio signal reflected off a wall;

FIG. 3 is a block diagram of an example ultrasonic mapping system that implements the techniques of this disclosure;

FIG. 4 is a schematic diagram of example user computing devices communicating sensor data/round trip time data with each other to perform a location estimate;

FIG. 5 is an example graph illustrating movement of a user over time indicating that the user is approaching an object, such as a wall;

FIGS. 6-8 illustrate a user computing device at different positions relative to a wall and the resulting audio signals transmitted from the user computing device and reflected off the wall;

FIG. 9 is an example schematic diagram illustrating the sensor data being fused with the round trip time data from the audio signals to determine an accurate location estimate for the user; and

FIG. 10 is a flow diagram of an example method for determining a location of a user, which can be implemented in a computing device.

### DETAILED DESCRIPTION OF THE DRAWINGS

Generally speaking, the techniques of this disclosure allow a user computing device interchangeably referred throughout this disclosure as a “computing device,” to determine its location by transmitting and receiving audio signals reflected off nearby objects to determine distances to the objects. The computing device also determines its location by using sensor data from positioning sensors (e.g., GPS sensors), accelerometers, gyroscopes, IMUs, or any other suitable sensors. Then the computing device fuses the sensor data and the distance data from the audio signals to determine its location with sub-meter accuracy.

In some implementations, the techniques of this disclosure can be implemented solely on the user computing device without receiving data from a network server. In other implementations, the techniques of this disclosure includes a network server that trains a machine learning model for determining the location of a user using (i) several round trip times of audio signals and reflected audio signals, (ii) several sets of sensor data from positioning sensors, accelerometers, gyroscopes, or IMUs, and (iii) several known locations each corresponding to one of the round trip times and one of the sets of sensor data. Then the network server provides the trained machine learning model to the user computing device. The user computing device applies (i) the round trip times of transmitted and reflected audio signals, and (ii) the sensor data from sensors in the user computing device to the machine learning model to determine its location.

The network server may also generate or obtain a floor plan for the area surrounding the user or the building that the user enters, and may provide the floor plan to the user computing device. The user computing device may then use the floor plan to locate the user within a particular room using (i) ultrasonic data indicating distances to objects in the floor plan, and (ii) the sensor data.

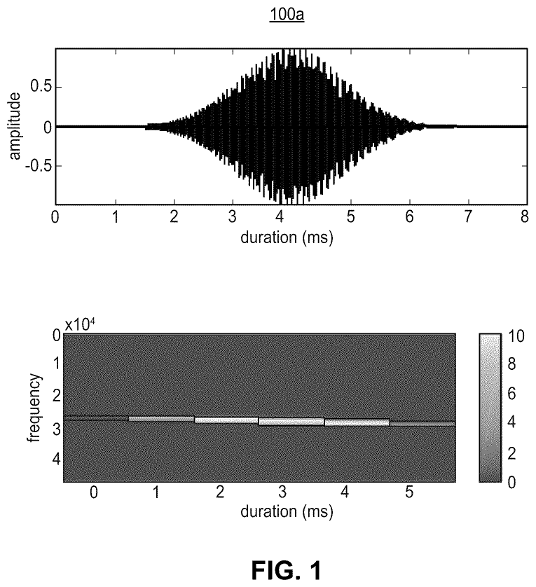

FIG. 1 illustrates an example audio signal 100a which may be transmitted via the speaker of a user computing device. The audio signal 100a may be a coded impulse signal having a particular pattern that can be detected when a reflected audio signal is received via the microphone of the user computing device. For example, the audio signal 100a may have a 26-31 kHz linear frequency with a pulse duration of 8 ms. In this manner, the audio signal 100a may be an ultrasonic signal which does not interfere with audible sound playing from the speaker.

The microphone then “listens” for a reflected audio signal having similar pulse characteristics as the audio signal 100a (e.g., within the same frequency range, having the same pulse duration, etc.). In some implementations, the microphone receives an audio signal and the user computing device convolves the transmitted audio signal 100a with the received audio signal using matched filtering to determine whether the received audio signal includes a reflected audio signal from the transmitted audio signal 100a. The user computing device may also filter the received audio signal around the frequency range of interest (e.g., 26-31 kHz) for the transmitted audio signal 100a to determine whether the received audio signal includes the reflected audio signal.

Then in response to detecting a reflected audio signal, the user computing device determines the round trip time (RTT) of the transmitted audio signal 100a and the reflected audio signal based on a time difference between the time when the audio signal 100a was transmitted and when the reflected audio signal was received. The user computing device may then determine a distance between an object, such as a wall and the user computing device based on the round trip time. For example, the distance, D, may be determined as ½ of c×RTT, where c is the speed of sound in air.

The user computing device may periodically transmit audio signals 100a via the speaker and receive reflected audio signals via the microphone to detect movement by the user over time. For example, the user computing device may transmit a subsequent audio signal 100a a threshold period of time after transmitting the previous audio signal 100a.

The threshold period of time may have a duration which is longer than a duration corresponding to a maximum range or distance in which a reflected audio signal can be detected from a transmitted audio signal. In this manner, the user computing device is unlikely to receive reflected audio signals from previously transmitted audio signals as the user computing device is receiving a reflected audio signal from a currently transmitted audio signal. The user computing device may then update a buffer of reflected audio signals (also referred to herein as “frames”) as they are received. For example, the buffer may include 20 frames which may be referred to as a block of frames. Each frame may have a duration which is the same as or similar to the period for transmitting consecutive audio signals 100a, and may include several samples of received audio data (e.g., at 1 ms intervals). Then the user computing device may analyze the buffer to detect movement by the user over time and determine the location of the user based on the movement data.

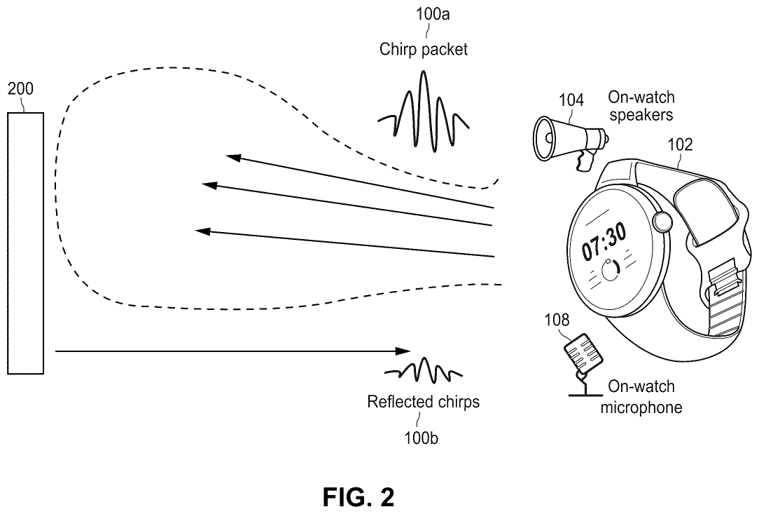

FIG. 2 illustrates the example audio signal 100a of FIG. 1 being transmitted from a user computing device 102 via speakers 104, bouncing off a wall 200, and being received as a reflected audio signal 100b at the user computing device 102 via a microphone 108. As mentioned above, the user computing device 102 identifies a correlation between the reflected audio signal 100b and the transmitted audio signal 100a by comparing pulse characteristics of the transmitted audio signal 100a to the pulse characteristics of the reflected audio signal 100b. In response to identifying the correlation, the user computing device 102 determines a distance from the user to the wall 200 based on the RTT of the transmitted audio signal 100a and the reflected audio signal 100b. As the user moves throughout a particular area the RTTs of transmitted/reflected audio signals 100a, 100b change. The user computing device detects movement by the user over time and determines the location of the user based on the movement data.

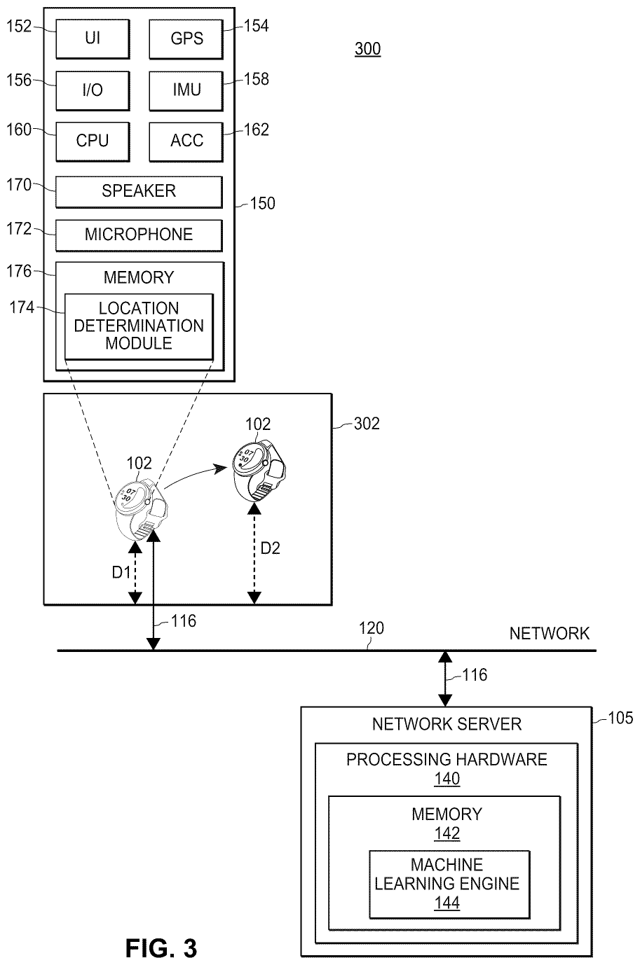

As mentioned above, in addition to using RTTs to determine the location of a user, the ultrasonic mapping system uses sensor data from sensors within the user computing device 102, such as a GPS, accelerometer, IMU, gyroscope, etc. FIG. 3 depicts an example ultrasonic mapping system 300 that can implement the techniques of this disclosure. The ultrasonic mapping system 300 includes a user computing device 102 communicatively coupled to a network server 105 via a network 120. The network 120 in general can include one or more wired and/or wireless communication links (e.g., communication link 116) and may include, for example, a wide area network (WAN) such as the Internet, a local area network (LAN), a cellular telephone network, or another suitable type of network.

The user computing device 102 can be any suitable type of computing device capable of wireless communications, such as a smart phone, a laptop computer, a tablet computer, a wearable device such as a smart watch, smart earbuds, smart glasses, etc., a personal digital assistant (PDA), a home assistant device, a virtual reality headset, etc. In some implementations, the user may have multiple user computing devices 102 within proximity of the user at the same time. For example, the user may have a smart phone, a smart watch, and/or smart earbuds. Each of the user computing devices 102 may communicate with each other to report sensor data and ultrasonic data detected at the respective user computing devices 102. Then one of the user computing devices 102 and/or the network server 105 may analyze the sensor data and the ultrasonic data from each of the user computing devices 102 to determine the location of the user.

The user computing device 102 includes processing hardware 150, which can include one or more general-purpose processors (e.g., CPUs) 160 and a computer-readable memory 176 (e.g., RAM, flash memory, ROM) storing machine-readable instructions executable on the general-purpose processor(s), and/or special-purpose processing units. The user computing device 102 also includes a user interface 152, for example for displaying an indication of the location of the user. Additionally, the user computing device 102 includes an input/output (I/O) module 156, and a network module (not shown), The network module may include one or more communication interfaces such as hardware, software, and/or firmware of an interface for enabling communications via a cellular network, a Wi-Fi network, or any other suitable network such as a network 120, discussed below. The I/O module 156 may include I/O devices capable of receiving inputs from, and providing outputs to, the ambient environment and/or a user. The I/O module 156 may include a touch screen, display, keyboard, mouse, buttons, keys, microphone, speaker, etc.

The user computing device 102 also includes one or several sensors such as a GPS 154, an IMU 158, an accelerometer 162, a gyroscope (not shown), a compass (not shown), etc. The IMU 158 may include an accelerometer 162 and a gyroscope to detect acceleration and angular velocity. The IMU 158 may also include a compass to detect the direction that the user computing device 102 is facing. The accelerometer 162 may be a tri-axis accelerometer, such that the user computing device 102 can detect acceleration in the X, Y, and Z directions. Additionally, the gyroscope may detect rotation along the pitch axis, the yaw axis, and the roll axis. In this manner, the IMU 158 has six degrees of freedom with variance in the measurements for each degree of freedom.

Still further, the user computing device 102 includes speakers 170 for transmitting an audio signal 100a in the ultrasonic frequency range and a microphone 172 for receiving a reflected audio signal 100b. In this manner, the user computing device 102 can use existing components (e.g., the speakers 170 and the microphone 172) to transmit and receive ultrasonic data rather than requiring an additional sensor, such as an ultrasonic sensor. Additionally, by using the speakers 170, the user computing device 102 can create a broadband signal over a range of frequencies rather than using a self-selected frequency band as with an ultrasonic sensor. The speakers 170 also allow for frequency diversity compared to an ultrasonic sensor and reduce the likelihood of interference with other ultrasonic sensors.

In some implementations, the user computing device 102 includes several microphones 172 located at different positions within the user computing device 102. In this manner, the user computing device 102 can determine not only the distance between the user computing device 102 and an object but also the direction of the reflected audio signal 100b, and therefore the direction of the object relative to the user computing device 102.

For example, the user computing device 102 may determine the direction of the object by receiving the reflected audio signal 100b at each of the microphones 172. The user computing device 102 may then determine the direction of arrival of the reflected audio signal 100b based on a time difference at which each of the microphones 172 received the reflected audio signal 100b. In other implementations, the user computing device 102 determines the direction of arrival of the reflected audio signal 100b based on any suitable combination of the time difference at which each of the microphones 172 received the reflected audio signal 100b and the orientation of the user computing device 102 determined from the sensor data. In various implementations, the user computing device 102 can include fewer components than illustrated in FIG. 3 or, conversely, additional components.

The memory 176 may store an operating system (OS) (not shown), which can be any type of suitable mobile or general-purpose operating system. The memory 176 may also store instructions for implementing a location determination module 174. The location determination module 174 may analyze the sensor data from the sensors 154, 158, 162 and the ultrasonic data from the speakers 170 and the microphone 172 to determine the location of the user.

In some implementations, the location determination module 174 determines an initial location for the user, for example from the GPS sensor 154. In other implementations, the user may input their initial location, such as the entrance of a particular building. The location determination module 174 obtains sensor data and ultrasonic data for the initial location. Then the location determination module 174 periodically or continuously obtains updated sensor data and ultrasonic data to detect movement from the initial location. The location determination module 174 determines an updated location of the user based on the distance and the direction of the movement from the initial location.

For example, at a first time period, the user computing device 102 may transmit a first audio signal 100a via the speaker 170 and receive a first reflected audio signal 100b via the microphone 172. Then the location determination module 174 may determine a first RTT of the first audio signal 100a and the first reflected audio signal 100b.

At a second time period, the user computing device 102 may transmit a second audio signal 100a via the speaker 170 and receive a second reflected audio signal 100b via the microphone 172. Then the location determination module 174 may determine a second RTT of the second audio signal 100a and the second reflected audio signal 100b. The location determination module 174 may determine a change in position of the user based on the change in RTTs from the first RTT to the second RTT.

In some implementations, the location determination module 174 presents an indication of the location of the user, for example via a map display. The location determination module 174 may present a floor plan for a building where the user is located. Then the location determination module 174 may present the indication of the user's location relative to the floor plan. For example, the user computing device 102 may present a location indicator for the user (e.g., a blue dot) in the southeast corner of the floor plan.

The network server 105 can be any suitable type of computing device capable of communicating with the user computing device 102, over the network 120. The network server 105 includes processing hardware 140, which can include one or more general-purpose processors (e.g., CPUs) and a computer-readable memory 142 (e.g., RAM, flash memory, ROM) storing machine-readable instructions executable on the one or more general-purpose processor(s), and/or special-purpose processing units. The memory 142 may store an OS (not shown), which can be any type of suitable mobile or general-purpose operating system.

The memory 142 may also store instructions for implementing a machine learning engine 144. In some implementations, the machine learning engine 144 trains a machine learning model using known location of users in a particular environment and corresponding sensor data and ultrasonic data for each known location, such as distance measurements from RTTs, orientation measurements, acceleration measurements, etc. The machine learning model then estimates a location of a user in the environment using sensor data and ultrasonic data from the user's computing device 102.

To generate the machine learning model, the machine learning engine 144 may classify subsets of the training data based on the known locations within the particular environment. In some implementations, the machine learning engine 144 may classify subsets of the training data into a range of known locations. For example, a first subset of the training data may include scenarios where the user was in the northeast corner of a room. A second subset of the training data may include scenarios where the user was near the center of the south wall of the room, etc. In these examples, the “northeast corner” and “near the center of the south wall” each represent a range of known locations, and the “room” represents the particular environment.

Then the machine learning engine 144 may analyze the subsets to generate the machine learning model. The machine learning model may be generated using various machine learning techniques such as a regression analysis (e.g., a logistic regression, linear regression, or polynomial regression), k-nearest neighbors, decisions trees, random forests, boosting, neural networks, support vector machines, deep learning, reinforcement learning, Bayesian networks, etc.

The machine learning engine 144 may then provide the trained machine learning model to the user computing device 102. Then the user computing device 102 may apply sensor data and ultrasonic data obtained at the user computing device 102 as an input to the trained machine learning model to determine the location of the user. In some implementations, the user computing device 102 may apply changes in the sensor data and/or the ultrasonic data obtained over time at the user computing device 102 to the trained machine learning model to determine the location of the user.

In other implementations, the user computing device 102 may provide the sensor data, the ultrasonic data and/or changes in the sensor data and the ultrasonic data over time to the network server 105. The network server 105 may then determine the location of the user by applying the sensor data, the ultrasonic data and/or changes in the sensor data and the ultrasonic data as an input to the trained machine learning model or by analyzing the sensor data, the ultrasonic data, and/or changes in the sensor data and the ultrasonic data in any other suitable manner. Then the network server 105 may provide, as an output, an indication of the determined location to the user computing device 102.

Also in some implementations, the network server 105 may generate a floor plan for a building (environment) where the user is located or obtain the floor plan from a map data server, for example. The network server 105 may then provide the floor plan to the user computing device 102 which may display an indication of the user's current location within the floor plan, for example on a map display.

The location determination module 174 and the machine learning engine 144 can operate as components of an ultrasonic mapping system, where the functionality of either the location determination module 174 or the machine learning engine 144 can be implemented in whole or in part by either of the user computing device 102 or the network server 105. Alternatively, the ultrasonic mapping system can include only server-side components and simply provide the location determination module 174 with locations of the user. As another alternative, the entire functionality of the machine learning engine 144 can be implemented in the location determination module 174.

In the example implementation of FIG. 3, the user computing device 102 is in a building 302, the building 302 being an example of a particular environment. While the embodiments described herein focus primarily on the user computing device 102 being within an indoor environment for determining an indoor position of the user, this is for ease of illustration only. The user computing device 102 can also determine its outdoor location in an outdoor environment using the techniques described herein.

In any event, as shown in FIG. 3, at a first time interval, t₁, the user computing device 102 is at a first location having a first distance, D₁, from the south wall. Then at a second time interval, t₂, the user moves toward the north wall and is at a second location having a second distance, D₂, from the south wall which is further than D₁. The location determination module 174 may determine the second location of the user based on the first location, the change in the distance (D₂−D₁) detected using RTTs from transmitted/reflected audio signals 100a, 100b, the direction in which the user accelerated according to the IMU 158 or the accelerometer 162, and/or the change in the orientation of the user computing device according to the IMU 158, the gyroscope, or the compass. In some implementations, each of these measurements may have associated confidence intervals. The location determination module 174 may then apply the measurements and/or the associated confidence intervals to the trained machine learning model to determine the location of the user.

In another implementation, the location determination module 174 may combine the measurements and/or the associated confidence intervals in any other suitable manner to determine the location of the user. For example, the location determination module 174 may determine the location of the user by using a particle filter. More specifically, the location determination module 174 may determine a first location estimate with a first confidence level from the change in RTTs, and a second location estimate with a second confidence level from the acceleration and/or orientation data from the IMU 158.

For example, the user computing device 102 may determine the second location estimate by determining the user's acceleration as a function of time and the direction(s) in which the user accelerated. Then the user computing device 102 may integrate the user's acceleration as a function of time to determine the user's change in velocity as a function of time, and may integrate the user's change in velocity as a function of time to determine the user's change in position as a function of time. The user computing device 102 may determine the user's initial position from the GPS sensor 154 and may determine the second location estimate for the user at a particular time using the initial position and the user's change in position at the particular time.

The particle filter may combine the location estimates and confidence levels from each of the sensors to generate a location estimate with a lower margin of error than the confidence levels for the individual sensors. The particle filter may combine the location estimates and confidence levels in any suitable manner, such as assigning weights to each of the location estimates. The particle filter may also generate probability distributions for the location estimates in accordance with their respective confidence levels (e.g., using a Gaussian distribution where the confidence level corresponds to two standard deviations). The particle filter may then combine the probability distributions for the location estimates using Bayesian estimation to calculate an MMS estimate.

More specifically, the particle filter may obtain N random samples of the probability distributions called particles to represent the probability distributions and assign a weight to each of the N random samples, where the weight is proportional to the likelihood of observing the particle according to the probability distributions. The particle filter then combines weighted particles to determine the location estimate having a confidence level with a lower margin of error than the confidence levels for the individual sensors.

As mentioned above, the user may have multiple user computing devices 102 proximate to the user. Each user computing device 102 may obtain at least some of the sensor data and/or ultrasonic data and may combine the sets of sensor data and/or ultrasonic data with each other to determine the user's location. In some implementations, each of the sets of sensor data and/or ultrasonic data may be applied to the particle filter or the trained machine learning model to generate the location estimate.

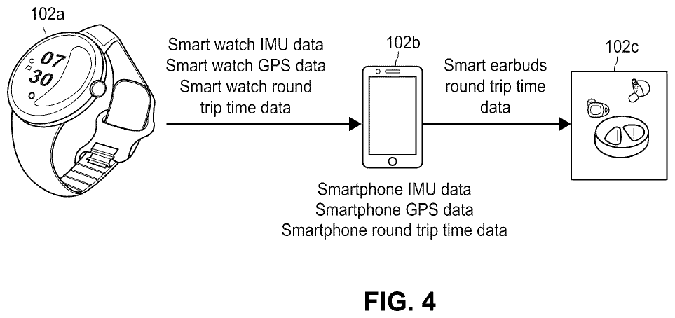

FIG. 4 illustrates example user computing devices 102a-102c which may communicate sensor data/ultrasonic data with each other to determine the user's location. As shown in FIG. 4, the user computing devices 102a-102c may include a smart watch 102a, a smart phone 102b, and smart earbuds 102c. Additional or alternative user computing devices 102a-102c may also communicate with each other to determine the user's location. The user computing devices 102a-102c may communicate with each other over a short-range communication link, such as Bluetooth™, Wi-Fi, etc., or a long-range communication link, such as the Internet.

In some implementations, the user computing devices 102a-102c may select a primary device to receive and analyze the sets of sensor/ultrasonic data to determine the user's location. In other implementations, each user computing device 102a-102c may transmit its sensor/ultrasonic data to the network server 105 which combines the sensor/ultrasonic data to determine the user's location.

In the example shown in FIG. 4, the smart phone 102b is selected as the primary device. The smart watch 102a generates a first set of IMU data, GPS data, and RTT data and transmits the first set of IMU data, GPS data, and RTT data to the smart phone 102b. The smart phone 102b generates a second set of IMU data, GPS data, and RTT data. The smart earbuds 102c generate a third set of RTT data from speakers and a microphone in the smart earbuds 102c but do not generate IMU or GPS data. Then the smart earbuds 102c transmit the third set of RTT data to the smart phone 102b. The smart phone 102b then analyzes the three sets of data to determine the location of the user, or transmits the three sets of data to the network server 105 to determine the location of the user.

For example, the smart phone 120b may determine the location of the user from each set of RTT data in the manner described above. The smart phone 120b may also determine the location of the user from each set of IMU data by determining the user's acceleration as a function of time and the direction(s) in which the user accelerated. Then the smart phone 120b may integrate the user's acceleration as a function of time to determine the user's change in velocity as a function of time, and may integrate the user's change in velocity as a function of time to determine the user's change in position as a function of time. The smart phone 120b may determine the user's initial position from each set of GPS data and may determine the location of the user at a particular time using the initial position and the user's change in position at the particular time. Then the smart phone 120b may average or take a weighted average of the locations from each set of RTT data and/or each set of IMU/GPS data to determine the user's location. In other implementations, the smart phone 120b may average or take a weighted average of each set of RTT data and each set of IMU/GPS data to determine the user's location based on the averaged set of RTT data and the averaged set of IMU/GPS data.

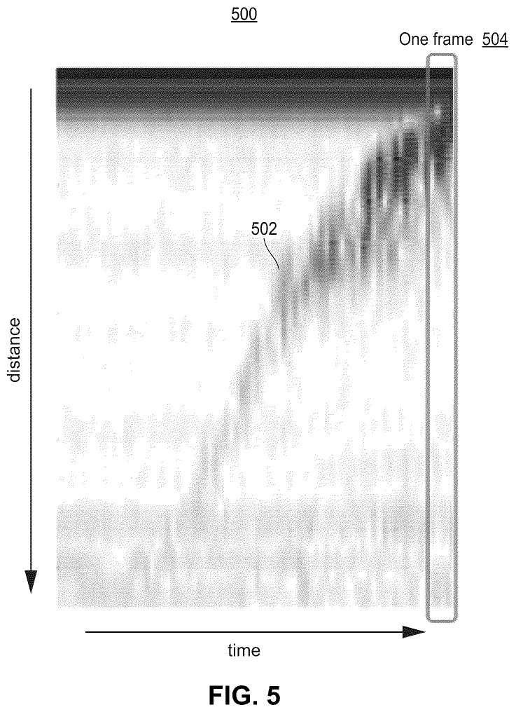

FIG. 5 illustrates an example graph 500 of RTT data over time. As mentioned above, when a user computing device 102 transmits an audio signal 100a, a received audio signal is analyzed for example, using filters and convolution techniques. Based on the analysis, the user computing device 102 identifies a correlation between the received audio signal and the transmitted audio signal 100a to therefore determine that the received audio signal includes a reflected audio signal 100b from the transmitted audio signal 100a. The user computing device 102 then determines a distance between the user computing device 102 and an object based on the time lag from when the audio signal 100a is transmitted and the reflected audio signal 100b is received.

In the graph 500, the x-axis indicates time, and the y-axis indicates distance to the object, where the distance increases from the top to the bottom. The data points on the graph 500 are darker where the correlation between the received audio signal and the transmitted audio signal 100a is higher. Accordingly, the positively-sloped stripe feature 502 on the graph 500 indicates that the user is moving toward the object (e.g., a wall) at almost constant velocity.

More specifically, the time axis is divided into frames 504 which have durations which are the same as or similar to the period for transmitting consecutive audio signals 100a. Within each frame, the audio samples collected in the frame are assigned a color from light gray to dark black indicating their level of correlation with the transmitted audio signal 100a. Highly correlated samples are displayed in dark black while audio samples with almost no correlation to the transmitted audio signal 100a are displayed in light gray, and audio samples with some correlation to the transmitted audio signal 100a are displayed in darker gray/light black. As shown in the graph 500, in the first few frames the darkest colored points within the frame are near the maximum distance from the object. Then over the next several frames, the distance to the object decreases until the distance is near zero indicating that the user is approaching the object.

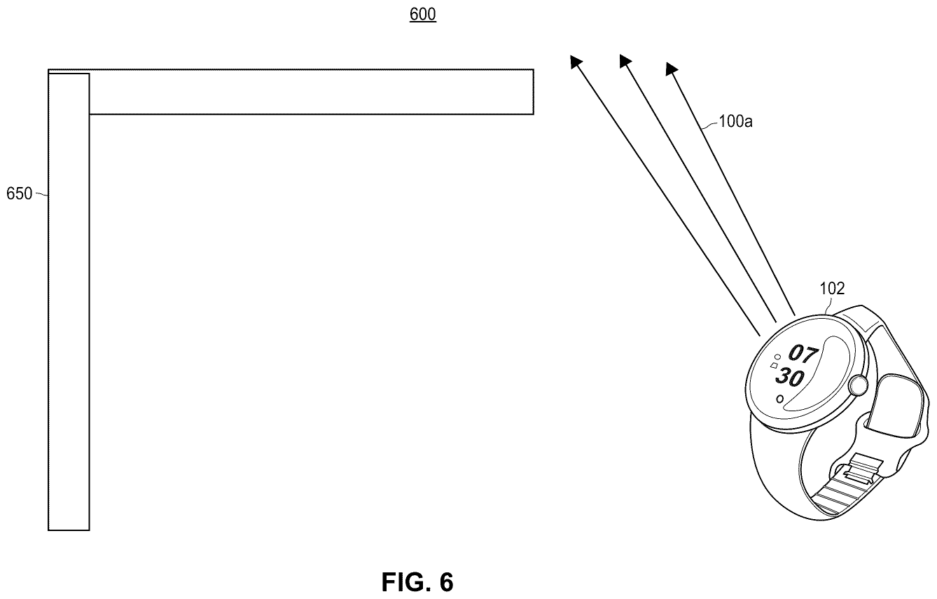

FIGS. 6-8 illustrate example audio signals 100a transmitted from the user computing device 102 at different positions relative to a wall 650. In the example scenario 600 as shown in FIG. 6, the transmitted audio signals 100a do not reach the wall. Accordingly, the user computing device 102 does not receive a reflected audio signal 100b that is correlated with the transmitted audio signal 100a or the correlation with received audio signals will be near zero.

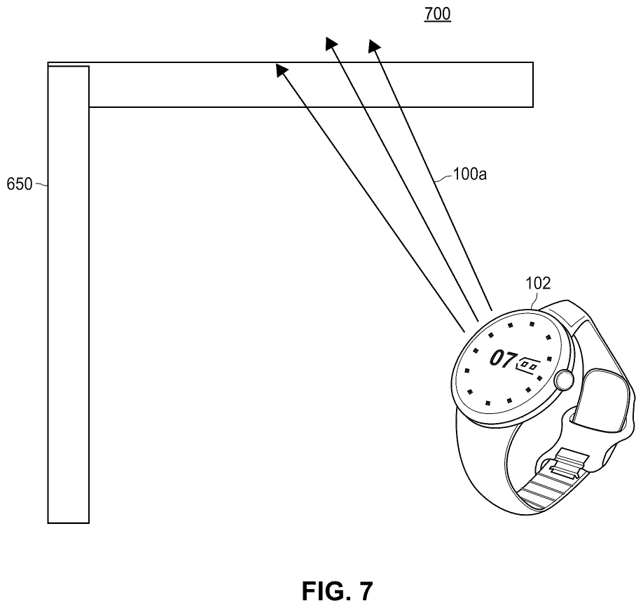

In the example scenario 700 as shown in FIG. 7, the user computing device 102 moves closer to the wall 650, and the transmitted audio signal 100a reflects off the wall 650. Accordingly, the user computing device 102 receives a reflected audio signal 100b that is correlated with the transmitted audio signal 100a. The user computing device 102 determines the distance to the wall 650 based on the RTT of the transmitted and reflected audio signals 100a, 100b.

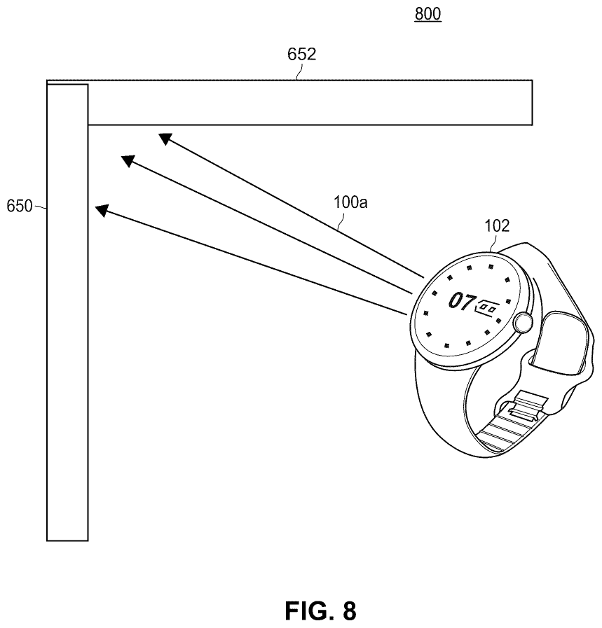

In the example scenario 800 as shown in FIG. 8, the user computing device 102 faces the corner of the wall 650, and transmits an audio signal 100a that reflects off both of the adjacent walls 650, 652. Accordingly, the user computing device 102 receives a reflected audio signal 100b that is correlated with the transmitted audio signal 100a. The user computing device 102 determines the distance to the wall 650 based on the RTT of the transmitted and reflected audio signals 100a, 100b. Additionally, the reflected audio signal 100b may include multiple peaks due to inter-wall reflections creating a tailing effect. The user computing device 102 may analyze the multiple peaks, so that the user computing device 102 not only determines the distance to the wall 650 but also determines that the user is proximate to a corner of the room based on detecting multiple peaks. The user computing device 102 can then improve the location accuracy further by ensuring that the determined location is proximate to a corner, and can adjust the location determination accordingly.

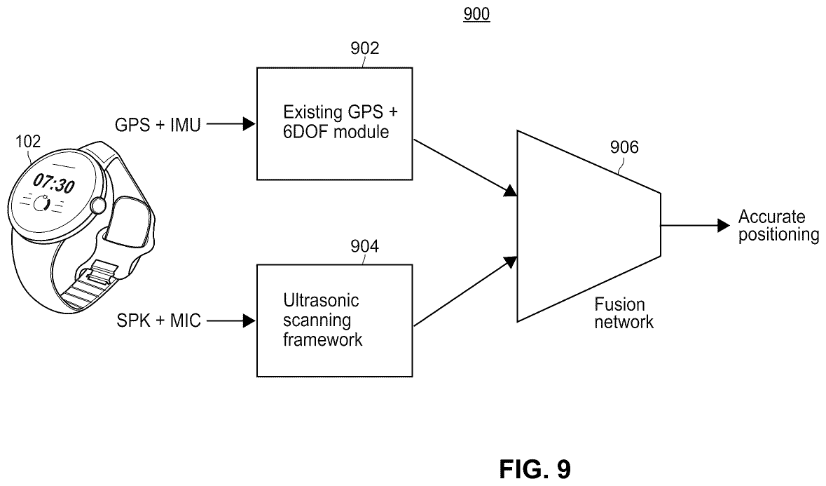

FIG. 9 is a schematic diagram 900 illustrating the sensor data being fused with the RTT data from the audio signals to determine an accurate location estimate for the user. The user computing device 102 provides sensor data 902 from the sensors 154, 158, 162 and the ultrasonic data 904 from the speakers 170 and the microphone 172 to a fusion network 906 which may be included in the location determination module 174 of the user computing device 102 or the machine learning engine 144 of the network server 105.

The sensor data 902 may include positioning data from the GPS 154, acceleration data in the X, Y, and Z directions from the IMU 158 or the accelerometer 162, and orientation data from the IMU 158, the gyroscope, or the compass.

The fusion network 906 may include a set of rules for combining the sensor data 902 with the ultrasonic data 904 to determine the user's location. For example, the fusion network 906 may determine the distance traveled from an initial location or a previous location using the ultrasonic data 904 and the direction the user traveled in using the orientation data 902. Then the fusion network 906 determines the user's location based on the distance traveled and the direction the user traveled in.

In other implementations, the fusion network 906 determines the location of the user by using a particle filter. More specifically, the fusion network 906 may determine a first location estimate with a first confidence level from the change in RTTs over time in the ultrasonic data 904, and a second location estimate with a second confidence level from the acceleration and/or orientation data from the IMU 158. The particle filter may combine the first and second location estimates and first and second confidence levels in any suitable manner, such as assigning weights to each of the location estimates. The particle filter may also generate probability distributions for the first and second location estimates in accordance with their respective confidence levels (e.g., using a Gaussian distribution where the confidence level corresponds to two standard deviations). The particle filter may then combine the probability distributions for the first and second location estimates using Bayesian estimation to calculate an MMS estimate.

In another example, the fusion network 906 may determine a first change in distance estimate with a first confidence level from the change in RTTs in the ultrasonic data 904, and a second change in distance estimate with a second confidence level from the acceleration data from the IMU 158. The particle filter may then combine the first and second change in distance estimates and first and second confidence levels in any suitable manner, such as assigning weights to each of the change in distance estimates to determine the distance the user traveled from an initial or previous location.

Additionally, the fusion network 906 may determine a first orientation estimate with a third confidence level from the time difference at which each of several microphones 172 in the user computing device received a reflected audio signal 100b. The fusion network 906 may also determine a second orientation estimate with a fourth confidence level from the IMU 158. The particle filter may then combine the first and second orientation estimates and third and fourth confidence levels in any suitable manner, such as assigning weights to each of the orientation estimates to determine the direction the user traveled from the initial or previous location. Then the fusion network 906 may combine the distance the user traveled with the direction the user traveled from the initial or previous location to determine the user's current location.

In yet other implementations, the fusion network 906 determines the location of the user by training a machine learning model or obtaining a trained machine learning model. The machine learning model is trained using known locations of users and corresponding sensor data and ultrasonic data for each known location, such as distance measurements from RTTs, time difference of arrival measurements from reflected audio signals 100b, orientation measurements, acceleration measurements, change in distance measurements from changes in RTTs, change in acceleration measurements, change in orientation measurements, etc. The fusion network 906 then applies the sensor data 902 and the ultrasonic data 904 to the trained machine learning model to determine the location of the user.

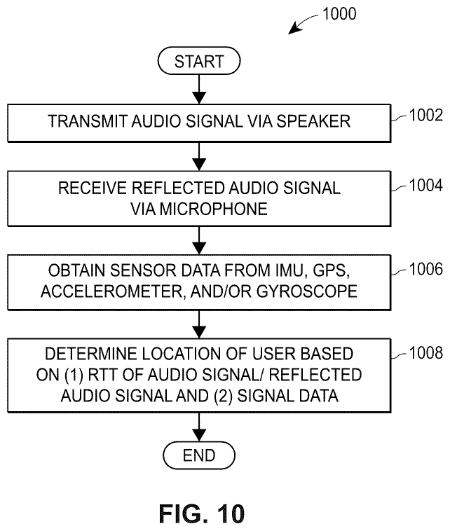

FIG. 10 is a flow diagram of an example method 1000 for determining a location of a user. The method 1000 can be implemented in a set of instructions stored on a computer-readable memory and executable at one or more processors of a user computing device 102.

At block 1002, the user computing device 102 transmits an audio signal 100a via a speaker 170. The audio signal 100a may be a coded impulse signal having a particular pattern that can be detected when a reflected audio signal is received via the microphone of the user computing device. For example, the audio signal 100a may have a 26-31 kHz linear frequency with a pulse duration of 8 ms.

Then at block 1004, the user computing device 102 receives a reflected audio signal 100b via the microphone 172. The reflected audio signal 100b may be a response impulse signal corresponding to the coded impulse signal. For example, to detect the reflected audio signal 100b, the user computing device 102 may compare pulse characteristics of a received audio signal to pulse characteristics of the transmitted audio signal 100a. If the pulse characteristics of the received audio signal match the pulse characteristics of the transmitted audio signal 100a, the user computing device 102 determines that the received audio signal includes a reflected audio signal 100b from the transmitted audio signal 100a.

In some implementations, the user computing device 102 convolves the transmitted audio signal 100a with the received audio signal using matched filtering to determine whether the received audio signal includes a reflected audio signal 100b. The user computing device 102 may also filter the received audio signal around the frequency range of interest for the transmitted audio signal 100a to determine whether the received audio signal includes the reflected audio signal 100b.

Then in response to detecting a reflected audio signal 100b, the user computing device 102 determines the RTT of the transmitted audio signal 100a and the reflected audio signal 100b based on a time difference between the time when the audio signal 100a was transmitted and the reflected audio signal 100b was received.

The user computing device may periodically transmit audio signals 100a via the speaker and receive reflected audio signals via the microphone to detect movement by the user over time.

At block 1006, the user computing device 102 may obtain sensor data from the sensors 154, 158, 162 such as the GPS 154, IMU 158, accelerometer 162, gyroscope, compass, etc. The sensor data may include position data, acceleration data, orientation data, angular velocity data, or any other suitable sensor data from position, acceleration, or orientation sensors.

Then at block 1008, the user computing device 102 determines the location of the user based on (i) the RTT of the transmitted audio signal 100a and the reflected audio signal 100b and (ii) the sensor data. For example, the user computing device 102 obtains a trained machine learning model from the network server 105 and applies the RTT and the sensor data to the trained machine learning model to determine the location of the user. The user computing device 102 may also apply other ultrasonic data to the trained machine learning model such as time difference of arrival data, changes in RTTs, etc. In another example, the user computing device 102 transmits the RTT, other ultrasonic data (e.g., time difference of arrival data, changes in RTTs, etc.), and/or the sensor data to the network server to determine the location of the user.

In yet another example, the user computing device 102 applies a set of rules to the RTT and the sensor data to determine the user's location. For example, the user computing device 102 may determine the distance traveled from an initial location or a previous location using a change in the RTT from the initial or previous location and the direction the user traveled in using the orientation data. Then the user computing device 102 determines the user's location based on the distance traveled and the direction the user traveled in. For example, if the initial location is the entrance of a building, the change in the RTT indicates the user traveled 5 meters, and the orientation data indicates the user traveled to the east, the user computing device 102 determines the user's location is 5 meters east of the entrance.

In another example, the user computing device 102 uses a particle filter to determine the user's location. For example, the user computing device 102 determines a first location estimate with a first confidence interval using the RTT and/or other ultrasonic data and a second location estimate with a second confidence interval using the sensor data. The particle filter may combine the first and second location estimates and first and second confidence levels in any suitable manner, such as assigning weights to each of the location estimates. The particle filter may also generate probability distributions for the first and second location estimates in accordance with their respective confidence levels (e.g., using a Gaussian distribution where the confidence level corresponds to two standard deviations). The particle filter may then combine the probability distributions for the first and second location estimates using Bayesian estimation to calculate an MMS estimate.

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. As used herein “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The method 1000 may include one or more function blocks, modules, individual functions or routines in the form of tangible computer-executable instructions that are stored in a computer-readable storage medium, which may be non-transitory, and executed using a processor of a computing device (e.g., a network server, a personal computer, a smart phone, a tablet computer, a smart watch, a mobile computing device, a home assistant device or other client computing device, as described herein). The method 1000 may be included as part of any backend server (e.g., a network server or any other type of server computing device, as described herein), client computing device modules of the example environment, for example, or as part of a module that is external to such an environment. Though the figures may be described with reference to the other figures for ease of explanation, the method 1000 can be utilized with other objects and user interfaces. Furthermore, although the explanation above describes steps of the method 1000 being performed by a specific device (such as a user computing device), this is done for illustration purposes only. The blocks of the method 1000 may be performed by one or more devices or other parts of the environment.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

Still further, the figures depict some embodiments of the example environment for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for an ultrasonic mapping system through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A method in a computing device for determining a location of a user, the method comprising:
transmitting, by one or more processors via a speaker, an audio signal;
receiving, at the one or more processors via a microphone, a reflected audio signal;
obtaining, at the one or more processors, sensor data from at least one of: a positioning sensor, an accelerometer, a gyroscope, or an inertial measurement unit (IMU); and
determining, at the one or more processors, a location of a user based on (i) a round trip time of the audio signal and the reflected audio signal, and (ii) the sensor data.

2. The method of claim 1, further comprising:
obtaining, by the one or more processors, a machine learning model trained using (i) a plurality of round trip times of audio signals and reflected audio signals, (ii) a plurality of sets of sensor data from at least one of: a positioning sensor, an accelerometer, a gyroscope, or an IMU, and (iii) a plurality of known locations each corresponding to one of the plurality of round trip times and one of the plurality of sets of sensor data; and
applying, by the one or more processors, the round trip time and the sensor data to the machine learning model to determine the location of the user.

3. The method of claim 1, wherein the microphone includes a plurality of microphones within the computing device, the reflected audio signal is received at each of the plurality of microphones, and determining the location of the user includes:
determining a direction of arrival of the reflected audio signal based on a time difference at which each of the plurality of microphones received the reflected audio signal.

4. The method of claim 1, wherein the audio signal is a first audio signal, the reflected audio signal is a first audio reflected audio signal, and determining the location of the user includes:
at a first time period:
transmitting, via the speaker, the first audio signal;
receiving, via the microphone, the first reflected audio signal;
at a second time period:
transmitting, via the speaker, a second audio signal;
receiving, via the microphone a second reflected audio signal; and
determining a change in position of the user based on a change in a first round trip time of the first audio signal and the first reflected audio signal and a second round trip time of the second audio signal and the second reflected audio signal.

5. The method of claim 4, further comprising:
determining an orientation of the user at the second time period based on the sensor data obtained at the second time period;
wherein determining the location of the user includes determining the location of the user based on the change in position of the user and the orientation of the user.

6. The method of claim 1, wherein the audio signal is a coded impulse signal and the reflected audio signal is a response impulse signal corresponding to the coded impulse signal.

7. The method of claim 1, wherein the one or more processors are included in a plurality of computing devices of the user, and wherein the plurality of computing devices are communicatively coupled to each other.

8. The method of claim 1, wherein determining the location of the user includes determining the location of the user using a particle filter.

9. A computing device for determining a location of a user comprising:
a speaker;
a microphone;
at least one of: (i) a positioning sensor, (ii) an accelerometer, (iii) a gyroscope, or (iv) an inertial measurement unit (IMU),
one or more processors; and
a computer-readable memory storing instructions thereon that, when executed by the one or more processors, cause the computing device to:
transmit, via the speaker, an audio signal;
receive, via the microphone, a reflected audio signal;
obtain sensor data from the at least one of: the positioning sensor, the accelerometer, the gyroscope, or the IMU; and
determine a location of a user based on the sensor data and a round trip time of the audio signal and the reflected audio signal.

10. The computing device of claim 9, wherein the instructions further cause the computing device to:
obtain a machine learning model trained using (i) a plurality of round trip times of audio signals and reflected audio signals, (ii) a plurality of sets of sensor data from at least one of: a positioning sensor, an accelerometer, a gyroscope, or an IMU, and (iii) a plurality of known locations each corresponding to one of the plurality of round trip times and one of the plurality of sets of sensor data; and
apply the round trip time and the sensor data to the machine learning model to determine the location of the user.

11. The computing device of claim 9, wherein the microphone includes a plurality of microphones, the reflected audio signal is received at each of the plurality of microphones, and to determine the location of the user, the instructions cause the computing device to:
determine a direction of arrival of the reflected audio signal based on a time difference at which each of the plurality of microphones received the reflected audio signal.

12. The computing device of claim 9, wherein the audio signal is a first audio signal, the reflected audio signal is a first audio reflected audio signal, and to determine the location of the user, the instructions cause the computing device to:
at a first time period:
transmit, via the speaker, the first audio signal;
receive, via the microphone, the first reflected audio signal;
at a second time period:
transmit, via the speaker, a second audio signal;
receive, via the microphone a second reflected audio signal; and
determine a change in position of the user based on a change in a first round trip time of the first audio signal and the first reflected audio signal and a second round trip time of the second audio signal and the second reflected audio signal.

13. The computing device of claim 12, wherein the instructions further cause the computing device to:
determine an orientation of the user at the second time period based on the sensor data obtained at the second time period,
wherein the location of the user is determined based on the change in position of the user and the orientation of the user.

14. The computing device of claim 9, wherein the audio signal is a coded impulse signal and the reflected audio signal is a response impulse signal corresponding to the coded impulse signal.

15. The computing device of claim 9, wherein the instructions further cause the computing device to:
obtain one or more round trip times or one or more sets of sensor data from one or more other computing devices of the user which are communicatively coupled to the computing device,
wherein the location of the user is further determined based on the one or more round trip times or one or more sets of sensor data.

16. The computing device of claim 9, wherein determining the location of the user includes determining the location of the user using a particle filter.

17. A computer-readable memory in a computing device storing instructions thereon that, when executed by one or more processors, cause the one or more processors to:
transmit, via a speaker, an audio signal;
receive, via a microphone, a reflected audio signal;
obtain sensor data from a at least one of: a positioning sensor, an accelerometer, a gyroscope, or an inertial measurement unit (IMU); and
determine a location of a user based on the sensor data and a round trip time of the audio signal and the reflected audio signal.

18. The computer-readable memory of claim 17, wherein the instructions further cause the one or more processors to:
obtain a machine learning model trained using (i) a plurality of round trip times of audio signals and reflected audio signals, (ii) a plurality of sets of sensor data from at least one of: a positioning sensor, an accelerometer, a gyroscope, or an IMU, and (iii) a plurality of known locations each corresponding to one of the plurality of round trip times and one of the plurality of sets of sensor data; and
apply the round trip time and the sensor data to the machine learning model to determine the location of the user.

19. The computer-readable memory of claim 17, wherein the microphone includes a plurality of microphones, the reflected audio signal is received at each of the plurality of microphones, and to determine the location of the user, the instructions cause the one or more processors to:
determine a direction of arrival of the reflected audio signal based on a time difference at which each of the plurality of microphones received the reflected audio signal.

20. The computer-readable memory of claim 17, wherein the audio signal is a first audio signal, the reflected audio signal is a first audio reflected audio signal, and to determine the location of the user, the instructions cause the one or more processors to:
at a first time period:
transmit, via the speaker, the first audio signal;
receive, via the microphone, the first reflected audio signal;
at a second time period:
transmit, via the speaker, a second audio signal;
receive, via the microphone a second reflected audio signal; and
determine a change in position of the user based on a change in a first round trip time of the first audio signal and the first reflected audio signal and a second round trip time of the second audio signal and the second reflected audio signal.
